(19) United States
(12) Patent Application Publication
(10) Pub. No.: US 2004/0075644 A1
(43) Pub. Date: Apr. 22, 2004

(54) Presentation system

(75) Inventors: Takenori Morinaga, Kawasaki (JP); Motoaki Satoyama, Sagamihara (JP); Yoshiaki Morimoto, Kawasaki (JP); Hideki Takano, Yokohama (JP)

Correspondence Address: McDermott, Will & Emery, 600, 13th Street, N.W., Washington, DC, 20005-3096, US

(73) Assignee: HITACHI, LTD.

(21) Appl. No.: 10/613,041

(22) Filed: Jul. 7, 2003

(30) Foreign Application Priority Data
Oct. 18, 2002 (JP) 2002-303708

(51) Int. Cl. G09G 5/08

(52) U.S. Cl. 345/157

(57) ABSTRACT

A presentation system includes a computer unit connected to at least radio transmitter-receiver unit and a display device, a plurality of mobile terminal devices communicating with the computer unit via the radio transmitter-receiver unit, and control unit incorporated in the computer unit to provide input information from the mobile terminal devices on the display device, reflecting information from mobile terminal devices on a screen of the display device.

### BACKGROUND OF THE INVENTION

1. Field of the Invention

The present invention relates to a presentation system having a function of displaying contents of presentation on a screen and a loudspeaker device for outputting a speech. In particular, the present invention relates to a system in which an auditor or a questioner can debate and discuss by using input devices, such as a cursor key and a microphone included in a mobile terminal device of the auditor or the questioner and sharing the presentation screen and the loudspeaker device, and can acquire information stored in a computer for presentation into the mobile terminal device.

2. Description of the Art

Heretofore, when performing presentation, there has been adopted a method of printing contents of presentation on a transparent film, projecting the printed contents onto a screen by using an overhead projector, and conveying the contents to a larger number of auditors. In the case where there is an alteration in the contents of presentation, recreation of a transparent film is needed and modification is not easy in this method. In creation of presentation, it is also possible to use a computer. Finally, however, work of printing the contents onto a transparent film is caused, and modification is not easy in the same way. Furthermore, repeated alterations lead to waste of transparent films as well. In addition, it is necessary to carry a large quantity of transparent films at the time of presentation. In a presentation method that has become to be used in recent years in order to improve such a situation, the contents of presentation created by the computer is not output to the transparent film, but the contents are transferred to a presentation computer in a place of meeting via a removable disk, a memory and a network, and displayed directly on a screen by using a large screen TV or a video projector. By using this method, it has become possible to perform dynamic presentation using an animation effect, instead of the static content display using a transparent film.

When performing the presentation with a computer used, the work of transferring presentation data of a lecturer to a presentation computer in a place of lecture meeting becomes necessary. A method for transferring presentation data easily by using infrared light or wireless communication is disclosed in JP-A-2000-222163 entitled “data display system and data display control method in data display system.” It is also shown that data exchange can be conducted between computers of a lecturer and a questioner by using this method.

The above-described presentation method is effective in saving labor in editing work, improving the presentation effect, and reducing consumption of resources such as transparent films. At the time of actual presentation, however, there are problems. Especially in talking back and force between the questioner and the lecturer at the time of questions and answers, it is necessary to aurally indicate presentation contents corresponding to a question to the lecturer. If the meeting place is large, it is necessary for a questioner to use a microphone and output speech from a loudspeaker device. The debate or discussion is often interrupted due to the time required for the aural indication and carrying the microphone.

Although the presentation contents are electronic data on the computer, the lecturer needs to make a handwritten note in order to store the contents, resulting in a problem.

In the data exchange method shown in JP-A-2000-222163, the form of data that can be handled by a computer of each person is not taken into consideration. Especially in the case where data transfer between mobile terminal devices for which there are many data forms from manufacturer to manufacturer is performed, therefore, the data cannot be utilized.

### SUMMARY OF THE INVENTION

With respect to the problems caused at the time of questions and answers and the data exchange, an object of the present invention is to reduce the unnecessary labor and time caused by debate or discussion between a lecturer and a questioner and work of conversion between different data, and thereby advance the presentation efficiently.

In order to achieve the object, the present invention has the following features.

In accordance with a first aspect of the present invention, a presentation system includes a mobile terminal device having an input unit, a radio transmitter circuit for radio-transmitting input information from the mobile terminal device, a radio receiver circuit for receiving the transmitted input information at a presentation computer, and a computer program for displaying the received input information on a screen of the presentation computer.

In accordance with a second aspect of the present invention, a presentation system includes a mobile terminal device having an input/output unit, a radio transmitter-receiver circuit for radio-transmitting input information from the mobile terminal device and receiving presentation information, a radio transmitter-receiver circuit for receiving the transmitted input information at the presentation computer and transmitting the presentation information from the presentation computer, and a computer program for displaying the received input information on a screen of the presentation computer.

In accordance with a third aspect of the present invention, a presentation system includes a mobile terminal device having a microphone, a radio transmitter circuit for radio-transmitting input speech from the mobile terminal device, a radio receiver circuit for receiving the transmitted speech at a presentation loudspeaker unit, and a circuit for outputting the received speech from the presentation loudspeaker unit.

In accordance with a fourth aspect of the present invention, a presentation system includes a mobile terminal device having an input/output unit, a radio transmitter-receiver circuit for radio-transmitting input information from the mobile terminal device and receiving presentation information, a radio transmitter-receiver circuit for receiving the transmitted input information at the presentation computer and transmitting the presentation information from the presentation computer, a computer program for displaying the received input information on a screen of the presentation computer, and an information format transforming unit for transforming the presentation information to a format that can be handled by each mobile terminal device.

In the configuration having the first aspect of the present invention, input information from a mobile terminal device having an input unit can be transmitted to a presentation computer and displayed on a screen. For example, when putting a question concerning the presentation, therefore, the questioner can use the input unit included in the individual mobile terminal device carried daily by the questioner in order to operate a cursor on the presentation screen. As a result, the questioner can promptly point out to a lecture content about which the questioner desires to put a question, without causing misunderstanding.

In the configuration having the second aspect of the present invention, presentation information from the presentation computer can be acquired at a mobile terminal device, in addition to the configuration having the first aspect. As a result, presentation information specified by using, for example, an input unit included in the mobile terminal device can be acquired easily.

In the configuration having the third aspect of the present invention, input information from a mobile terminal device having a microphone is transmitted to a loudspeaker unit for presentation and output thereby. For example, when putting a question to a lecturer who has performed presentation, it becomes unnecessary to carry a microphone to the questioner. As a result, a waste of time in questions and answers can be avoided.

In the configuration having the fourth aspect of the present invention, presentation information in the presentation computer can be transformed to a format of information that can be handled by a mobile terminal device, in addition to the configuration having the second aspect. For example, therefore, the acquired presentation information can be perused and edited on the mobile terminal device on the spot.

Other objects, features and advantages of the invention will become apparent from the following description of the embodiments of the invention taken in conjunction with the accompanying drawings.

### BRIEF DESCRIPTION OF THE DRAWINGS

FIG. 1 is a configuration diagram showing a first embodiment of a presentation system according to the present invention;

FIG. 2 is a configuration diagram showing a second embodiment of a presentation system according to the present invention;

FIG. 3 is a configuration diagram showing a third embodiment of a presentation system according to the present invention;

FIG. 4 is a configuration diagram showing a fourth embodiment of a presentation system according to the present invention;

FIG. 5 is a flow chart showing an operation of connection between a presentation system and a mobile terminal device;

FIG. 6 is a flow chart showing an operation conducted at the time of disconnection between a presentation system and a mobile terminal device;

FIG. 7 is a flow chart showing an operation conducted when a mobile terminal device orders a presentation system to move a cursor;

FIG. 8 is a flow chart showing an operation of selecting and acquiring a data file for presentation;

FIG. 9 is a flow chart showing an operation of a presentation system conducted when a speech output start is requested;

FIG. 10 is a flow chart showing an operation of a presentation system conducted when a speech output end is requested; and

FIG. 11 is a flow chart showing operations of cursor movement and a speech output in a presentation system.

### DESCRIPTION OF THE EMBODIMENTS

Hereafter, embodiments of the present invention will be described with reference to the drawings.

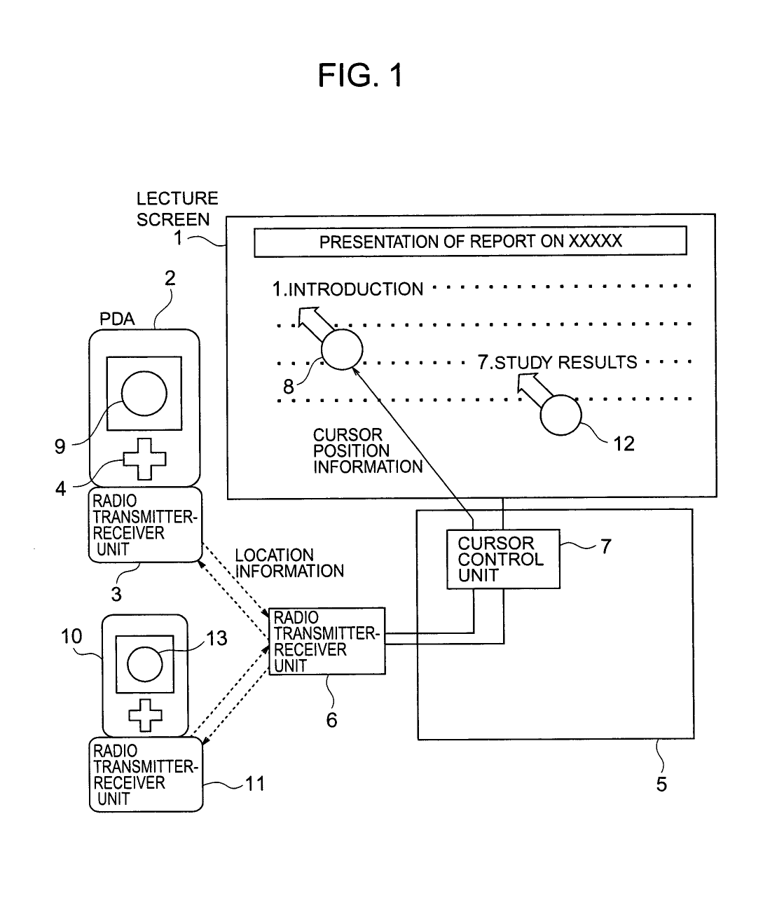

FIG. 1 is a block diagram showing a first embodiment of the present invention. In FIG. 1, reference numeral 1 denotes a screen for lecture, 2 a mobile terminal device for lecturer. Herein, a PDA (Personal Digital Assistant) is used as the mobile terminal device 2. Reference numeral 3 denotes a radio transmitter-receiver unit for a lecturer PDA, 4 an input unit for the PDA, 5 a computer for presentation, 6 a radio transmitter-receiver unit for the presentation computer, 7 a cursor control unit, 8 a cursor for lecturer, 9 a lecturer cursor identification icon, 10 a PDA for a questioner, 11 a radio transmitter-receiver unit for the questioner PDA, 12 a cursor for the questioner, and 13 a questioner cursor identification icon. If the PDA 2 transmits a link establishment request to the presentation computer 5 via the radio transmitter-receiver unit for the lecturer PDA 3, then the radio transmitter-receiver unit for the presentation computer receives the request, and the cursor control unit 7 displays the lecturer cursor 8 on the lecturer screen 1. At this time, a unique cursor identification information is returned to the lecturer PDA 2 via the radio transmitter-receiver unit 6, and the lecturer cursor identification icon 9 is displayed on a screen of the PDA 2. A link between the PDA 2 and the present system is thus established. After the link has been established, cursor identification information and cursor position information are transmitted via the radio transmitter-receiver units 3 and 6. The cursor control unit 7 redraws a cursor corresponding to the cursor identification information on the lecture screen 1, which is the lecturer cursor 8 in this case, according to the cursor position information.

Furthermore, by using a radio transmitter-receiver unit 6 capable of processing a plurality of link establishment requests, it is possible to display a plurality of cursors for lecturer and questioner on the lecture screen 1 and operate them from a plurality of PDAs. For example, the radio transmitter-receiver unit 6 accepts a link establishment request from the questioner PDA 10, and transmits it to the cursor control unit 7. The cursor control unit 7 determines identification information of a cursor that is not being used now on the lecture screen 1, and returns it to the questioner PDA 10 via the radio transmitter-receiver units 6 and 3. Processing conducted after the link establishment is the same as that conducted in the case where the lecturer PDA 2 is used.

According to the present embodiment, the cursors on the lecturer screen can be operated by using input units of the PDAs respectively owned by the lecturer and the questioner, respectively.

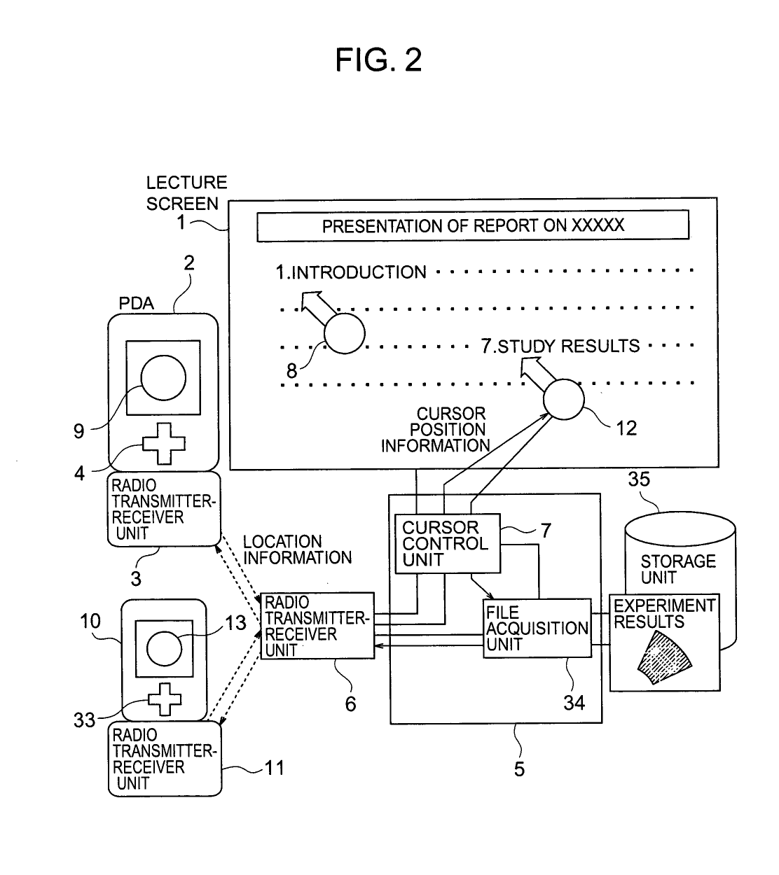

FIG. 2 is a block diagram showing a second embodiment of the present invention. In the present system, it is possible to acquire information concerning a lecture from the presentation computer into the lecturer PDA 2 and the questioner PDA 10, by adding a file acquisition unit 34 and a storage unit 35 to the presentation computer 5 having the configuration of the first embodiment of the present invention. The link establishment request and the cursor movement are conducted in the same way as the first embodiment of the present invention. For example, if the questioner cursor 12 is moved to a place that indicates a storage location of information in the presentation computer and an information acquisition request is transmitted to the presentation computer 5, then the cursor control unit 7 transmits the specified information storage location to the file acquisition unit 34. The file acquisition unit 34 takes out specified information from the storage unit 35, and the specified information is taken in the questioner PDA 10 via the radio transmitter-receiver units 6 and 11. By the way, the technique of displaying materials stored in the storage unit 35 on the lecture screen 1 is well known.

According to the present embodiment, the cursors 8 and 12 on the lecture screen 1 can be operated by using the PDAs 2 and 10 respectively owned by the lecturer and the questioner, respectively. In addition, it becomes possible to take information stored in the presentation computer 5 in the respective PDAs 2 and 10 by using those cursors.

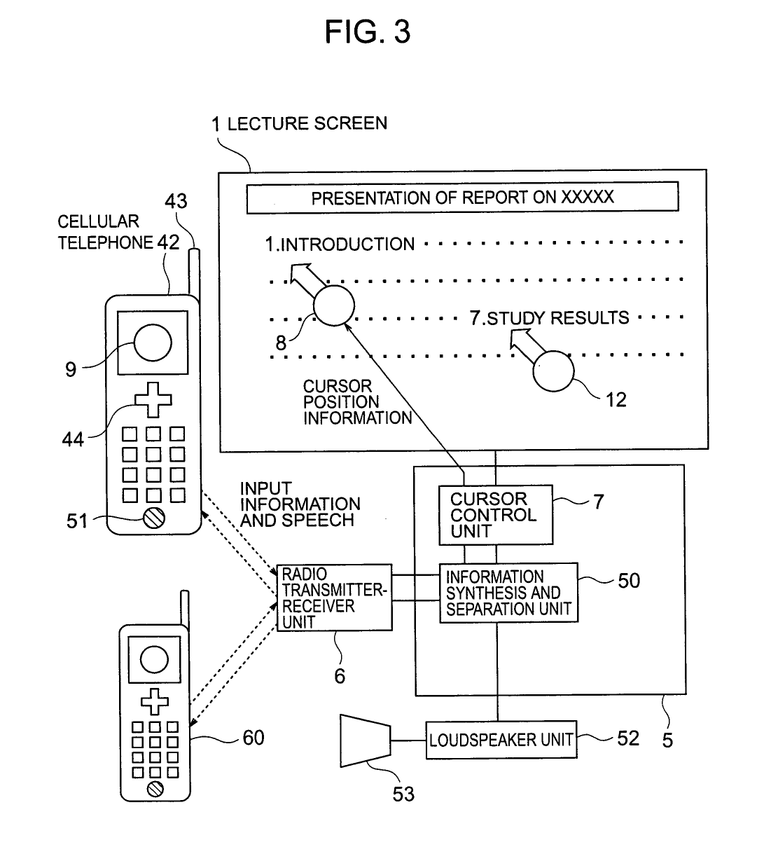

FIG. 3 is a block diagram showing a third embodiment of the present invention. In FIG. 3, reference numerals 1, 5, 6, 7, 8, 9 and 12 denote the same components as those shown in FIG. 1. Reference numeral 42 denotes a cellular telephone for a lecturer as a mobile terminal device, 43 a radio transmitter-receiver unit for the lecturer cellular telephone, 44 an input unit for the lecturer cellular telephone, 50 an information synthesis and separation unit, 51 a microphone for the lecturer cellular telephone, 52 a loudspeaker unit, 53 a speaker, and 60 a cellular telephone for a questioner as a mobile terminal device. The lecturer cellular telephone 42, the radio transmitter-receiver unit 43 for lecturer cellular telephone, and the input unit 44 for lecturer cellular telephone shown in FIG. 3 correspond to the lecturer PDA 2, the radio transmitter-receiver unit 3 for lecturer PDA, and the input unit 4 for lecturer PDA shown in FIG. 1, respectively. The lecturer cellular telephone 42 differs from the lecturer PDA 2 in that the lecturer cellular telephone 42 incorporates the microphone 51. Information for operating the lecturer cursor 8 and speech information input by the microphone 51 incorporated in the lecturer cellular telephone are combined, and radio communication with the presentation computer 5 is conducted. In FIG. 3, the link establishment between the lecturer cellular telephone 42 and the presentation computer 5, and the movement of the lecturer cursor are conducted in the same way as the first embodiment of the present invention. Since information transmitted from the lecturer cellular telephone 42 includes a combination of the information for moving the lecturer cursor and the speech input from the microphone incorporated in the lecturer cellular telephone, however, the information synthesis and separation unit 50 for separating them is added between the radio transmitter-receiver unit 6 for the presentation computer and the cursor control unit 7. The speech information separated by the information synthesis and separation unit 50 is transferred to the loudspeaker unit 52, and output by the speaker 53 in the place of meeting.

According to the present embodiment, the cursors 8 and 12 on the lecture screen 1 can be operated by using input units in the cellular telephones 42 and 60 respectively owned by the lecturer and the questioner, respectively. Speeches uttered to the microphones incorporated in the cellular telephones 42 and 60 can also be output by using the loudspeaker unit 52 and the speaker 53 in the place of meeting. In the present embodiment, the file transfer function described with reference to the second embodiment of the present invention has been omitted. Of course, however, the function may also be added.

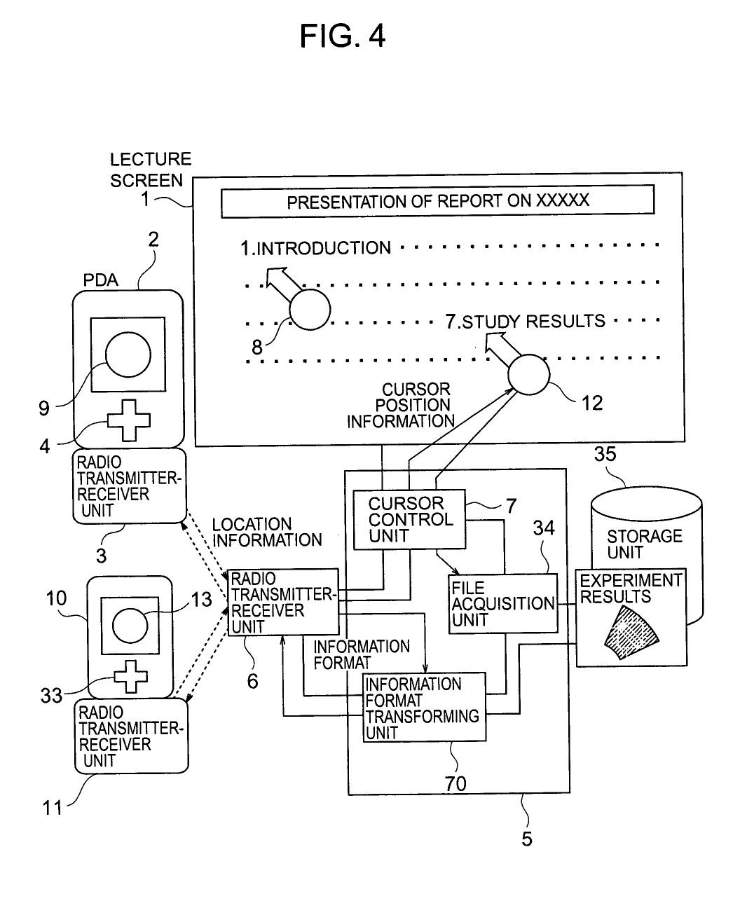

FIG. 4 is a block diagram showing a fourth embodiment of the present invention. In the present system, presentation information can be acquired in information formats of the lecturer PDA 2 and the questioner PDA 10, by adding an information format transforming unit 70 corresponding to various information formats between the file acquisition unit 34 and the radio transmitter-receiver unit 6 in the presentation computer 5 having the configuration of the second embodiment according to the present invention. The link establishment request, the cursor movement and the file acquisition method are conducted in the same way as the first and second embodiments of the present invention. At the time of link establishment, however, the questioner PDA 10 also transmits an information format that can be handled by the PDA at the same time. Presentation information acquired from the storage unit 35 by the file acquisition unit 34 according to an order from the questioner PDA 10 is transformed into a suitable information format by the information format transforming unit 70 in accordance with the information format previously acquired at the time of link establishment. The specified information is taken in the questioner PDA 10 via the radio transmitter-receiver units 6 and 11.

According to the present embodiment, the transformation of the information format that can be handled by the PDAs 2 and 10 respectively owned by the lecturer and the questioner can be conducted in the presentation computer 5. It becomes possible to peruse and edit presentation information taken in on the respective PDAs 2 and 10 on the spot.

In FIG. 4, the information format transforming unit 70 for transforming the information format of presentation data stored in the storage unit 35 to the information format handled by the PDA 10 is shown. By providing a format transforming software program for the questioner PDA 10 in the information format transforming unit 70, it becomes possible to download predetermined data from the Internet.

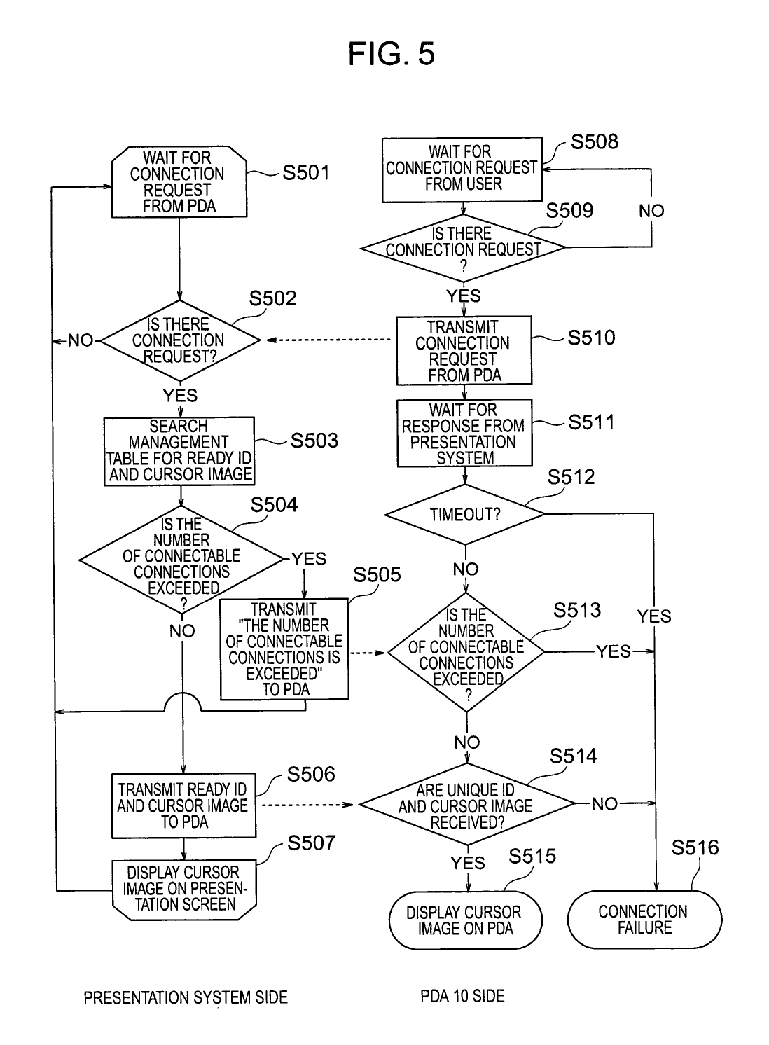

With reference to a flow chart shown in FIG. 5, operation conducted at the time of connection between the presentation system and the questioner PDA 10 will now be described.

Presentation system side having lecturer PDA 2:

1) A connection request from the questioner PDA 10 is waited for (S501).

2) If there is a connection request, then it is determined whether number of connectable PDAs is now exceeded. If exceeded, then a message “the number of connectable PDAs has been exceeded” is returned to the questioner PDA 10 (S502, S503, S504 and S505).

3) If not exceeded, the presentation system acquires a unique ID, which does not overlap the PDAs now in connection, and a cursor image that can be distinguished from other PDAs, from an ID management table (not illustrated), and returns them to the questioner PDA 10 (S504 and S506). On the ID management table, the ID and the cursor image are changed to “busy state.”

4) The cursor image transmitted to the questioner PDA 10 is displayed on the actual lecture screen 1, and the processing of the connection from the questioner PDA 10 is completed (S507).

5) A connection request from other PDAs is waited for (S501).

The questioner PDA 10 side:

1) A connection request from the user is waited for (S508).

2) If there is a connection request, then a connection request is transmitted from the questioner PDA 10 to the presentation system, i.e. the radio transmitter-receiver unit 6 of the computer 5, and a response from the presentation system is waited for (S509, S510 and S511).

3) If timeout occurs, then it turns out a “connection failure” and a message for informing the user to that effect is output on the screen of the questioner PDA 10 (S512, S513, S514 and S515).

4) If the message “the number of connectable PDAs has been exceeded” is received, then a message for informing the user to that effect is output on the screen (S516).

5) After the unique ID and the cursor image for the questioner PDA have been received, the received cursor image is displayed on the questioner PDA 10 and the connection is completed.

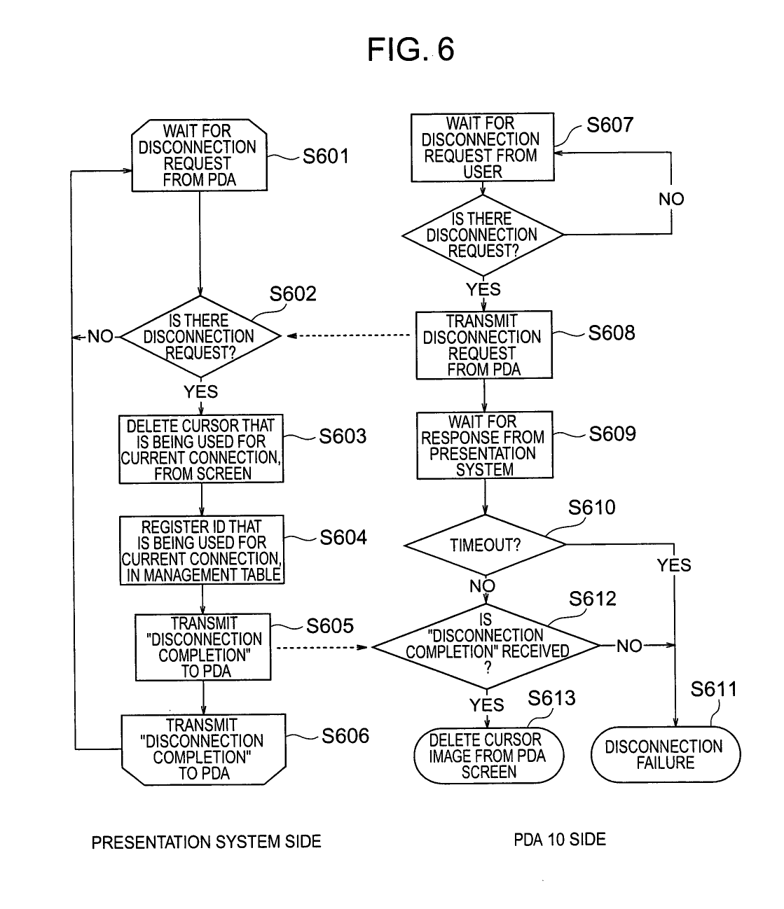

With reference to a flow chart shown in FIG. 6, operation conducted at the time of disconnection between the presentation system and the questioner PDA 10 will now be described.

Presentation system side:

1) A disconnection request from the questioner PDA 10 is waited for (S601).

2) If there is a disconnection request, then a cursor image that can be identified from an ID transmitted simultaneously is deleted from the lecture screen 1, and the ID and the cursor image are changed to the “ready state” on the ID management table (S602, S603 and S604).

3) A message “disconnection completion” is transmitted to the questioner PDA 10, and the processing of disconnection from the questioner PDA 10 is completed.

4) A disconnection request from other PDAs is waited for (S605 and S606).

The questioner PDA 10 side:

1) A disconnection request from the user is waited for (S607).

2) If there is a disconnection request, then a disconnection request is transmitted from the questioner PDA 10 to the presentation system, i.e. the radio transmitter-receiver unit 6 of the computer 5, and a response from the presentation system is waited for (S608 and S609).

3) If timeout occurs, then it turns out a “connection failure” and a message for informing the user to that effect is output on the screen of the questioner PDA 10 (S610, S611 and S612).

4) If the message “disconnection completion” is received, then a cursor image on the screen of the questioner PDA 10 is deleted, and the disconnection processing is completed (S612 and S613).

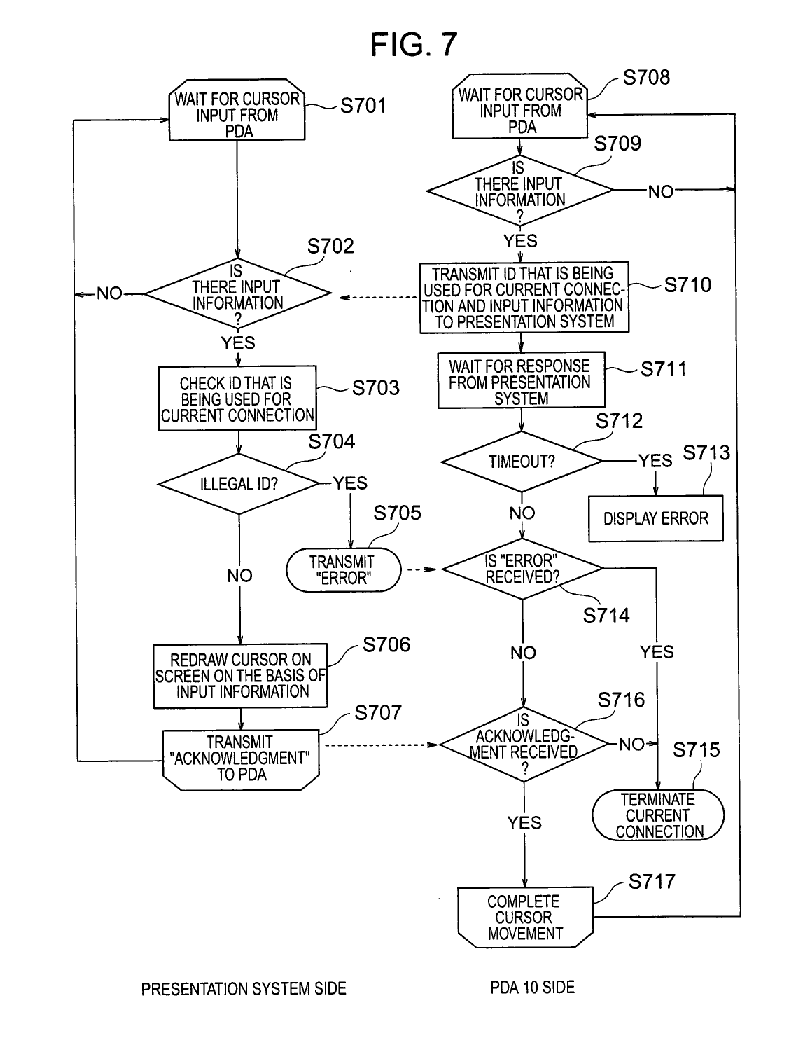

With reference to a flow chart shown in FIG. 7, operation conducted when the presentation system is ordered to move the cursor by the questioner PDA 10 will now be described.

Presentation system side:

1) A cursor movement request from the questioner PDA 10 is waited for (S701).

2) If there is a cursor movement request, then it is determined whether an ID transmitted simultaneously is an ID that is now in use. If the ID transmitted simultaneously is an ID that is not now in use, then an “error” message is returned to the questioner PDA 10, and the processing is finished (S702, S703, S704 and S705).

3) If the ID transmitted simultaneously is the correct ID, then a cursor on the lecture screen 1 is redrawn on the basis of simultaneously transmitted input information for the questioner PDA 10. For example, if the “upward” key is pressed, then the cursor image is shifted upward and redrawing is conducted (S704 and S706).

4) After redrawing, an “acknowledgment” message is transmitted to the questioner PDA 10, and the cursor movement processing is completed (S707).

5) A cursor movement request from other PDAs is waited for (S701).

The questioner PDA 10 side:

1) The questioner PDA 10 waits for the user to input cursor movement information by using the input unit thereon (S708).

2) If cursor movement information is input, then the questioner PDA 10 transmits an ID and cursor movement information now held thereby to the presentation system, and waits for a response from the presentation system (S709, S710 and S711).

3) If timeout occurs, then it turns out a “cursor movement failure” and a message for informing the user to that effect is output on the screen (S712 and S713).

4) If an “error” message is received, then the questioner PDA 10 regards the current connection as illegal, discards the ID held thereby, and deletes the cursor image on the screen as well (S714 and S715). If necessary, the processing is started from the “connection request” processing again (S501 in FIG. 5).

5) The “acknowledgment” message is received, and the cursor movement processing is completed (S716 and S717).

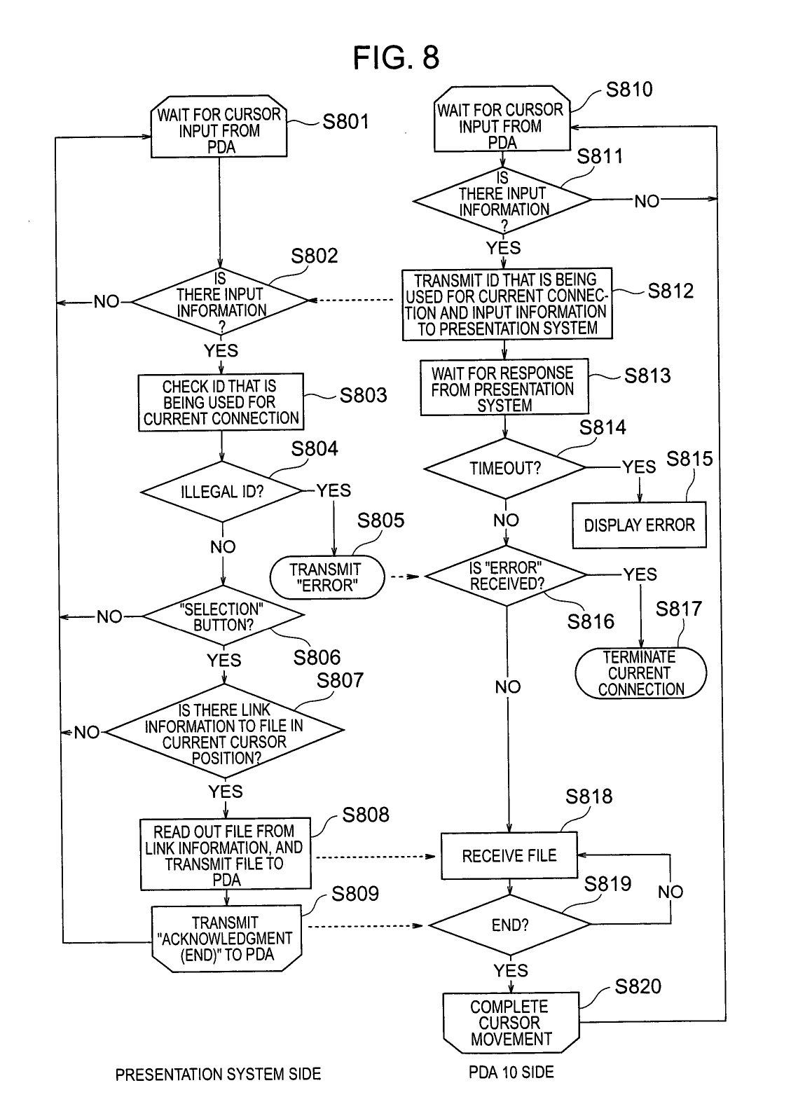

With reference to a flow chart shown in FIG. 8, operation of selecting and acquiring a data file for presentation in the presentation system shown in FIGS. 2 and 4 will now be described.

Presentation system side:

1) A cursor request from the questioner PDA 10 is waited for (S801).

2) If there is a cursor request, then it is determined whether an ID transmitted simultaneously is an ID that is now in use. If the ID transmitted simultaneously is an ID that is not now in use, then an “error” message is returned to the questioner PDA 10, and the processing is finished (S802, S803, S804 and S805).

3) If the ID transmitted simultaneously is the correct ID and the simultaneously transmitted input information of the questioner PDA 10 indicates “selection,” then it is determined whether the current position of the cursor is the position indicating the link information of a data file (S806 and S807).

4) If the cursor is not in a position representing link information of a data file, then the cursor information is disregarded. If the cursor is in the position representing link information of a data file, then a storage location of the pertinent data file is acquired, and the pertinent data file is acquired from the pertinent storage location in the storage unit 35 connected to the presentation system and transmitted to the questioner PDA 10 (S808).

5) After the transmission of the data file has been finished, an “acknowledgment” message is transmitted to the questioner PDA 10 and the data file transmission processing is completed (S809).

6) A subsequent data file selection & acquisition request from a questioner PDA 10 is waited for (S801).

The questioner PDA 10 side:

1) The questioner PDA 10 waits for the user to input cursor information by using the input unit thereon (S810).

2) If cursor movement information is input, then the questioner PDA 10 transmits an ID and cursor movement information now held thereby to the presentation system, and waits for a response from the presentation system (S811, S812 and S813).

3) If timeout occurs, then it turns out a “data file selection & acquisition failure” and a message for informing the user to that effect is output on the screen (S814 and S815).

4) If an “error” message is received, then the questioner PDA 10 regards the current connection as illegal, discards the ID held thereby, and deletes the cursor image on the screen as well (S816 and S817). If necessary, the processing is started from the “connection request” processing again (S501 in FIG. 5).

5) If the data file can be selected correctly, then the data file is transmitted from the presentation system and consequently reception processing is conducted (S816 and S818).

6) The “acknowledgment” message is received, and the data file selection & acquisition processing is completed (S820).

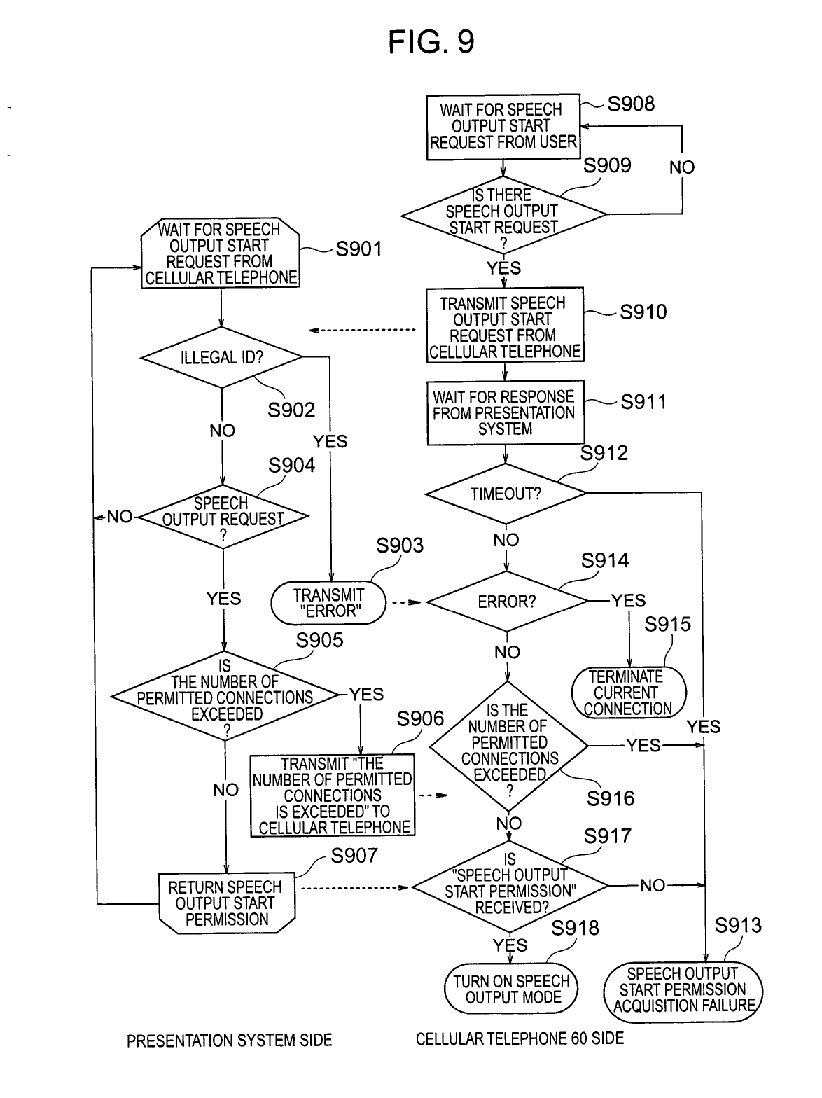

With reference to a flow chart shown in FIG. 9, operation of the presentation system shown in FIG. 3 at the time of speech output start request will now be described.

Presentation system side:

1) A speech output start request from the questioner cellular telephone 60 is waited for (S901).

2) If something is transmitted from the questioner cellular telephone 60, then it is determined whether an ID transmitted simultaneously is an ID that is now in use. If the ID transmitted simultaneously is an ID that is not now in use, then an “error” message is returned to the questioner cellular telephone 60, and the processing is finished (S902 and S903).

3) If the ID transmitted simultaneously is the correct ID and the simultaneously transmitted input information of the questioner cellular telephone 60 indicates “speech output start,” then it is determined whether the current number of connections permitted to output the speech is exceeded (S902, S904 and S905).

4) If the number of permitted connections is exceeded, then a message “the number of permitted connections has been exceeded” is transmitted to the questioner cellular telephone 60 (S906). If not exceeded, then a “speech output start permission” message is returned, and the processing for the speech output start request is completed.

5) A subsequent speech output start request from a questioner cellular telephone is waited for (S907).

The questioner cellular telephone 60 side:

1) The questioner cellular telephone 60 waits for the user to conduct operation for indicating “speech output start” by using the input unit thereon (S908).

2) If “speech output start” is input, then the questioner cellular telephone 60 transmits an ID now held thereby and a message representing “speech output start” to the presentation system, and waits for a response from the presentation system (S909, S910 and S911).

3) If timeout occurs, then it turns out a “speech output start failure” and a message for informing the user to that effect is output on the screen (S912 and S913).

4) If an “error” message is received, then the questioner cellular telephone 60 regards the current connection as illegal, discards the ID held thereby, and deletes the cursor image on the screen as well (S914 and S915). If necessary, the processing is started from the “connection request” processing again (S501 in FIG. 5).

5) If the message “the number of permitted connections has been exceeded” is received, then it means that the “speech output” has not been permitted, and the questioner cellular telephone 60 conducts nothing (S916 and S917). If necessary, the processing is started from the “connection request” processing again (S501 in FIG. 5).

6) If the “speech output start permission” message is received, then the “speech output mode” in the questioner cellular telephone 60 is set to “ON” and the speech output start request processing is completed. If necessary, for example, a display indicating “speech is being output” is effected on the screen of the questioner cellular telephone 60 (S917 and S918).

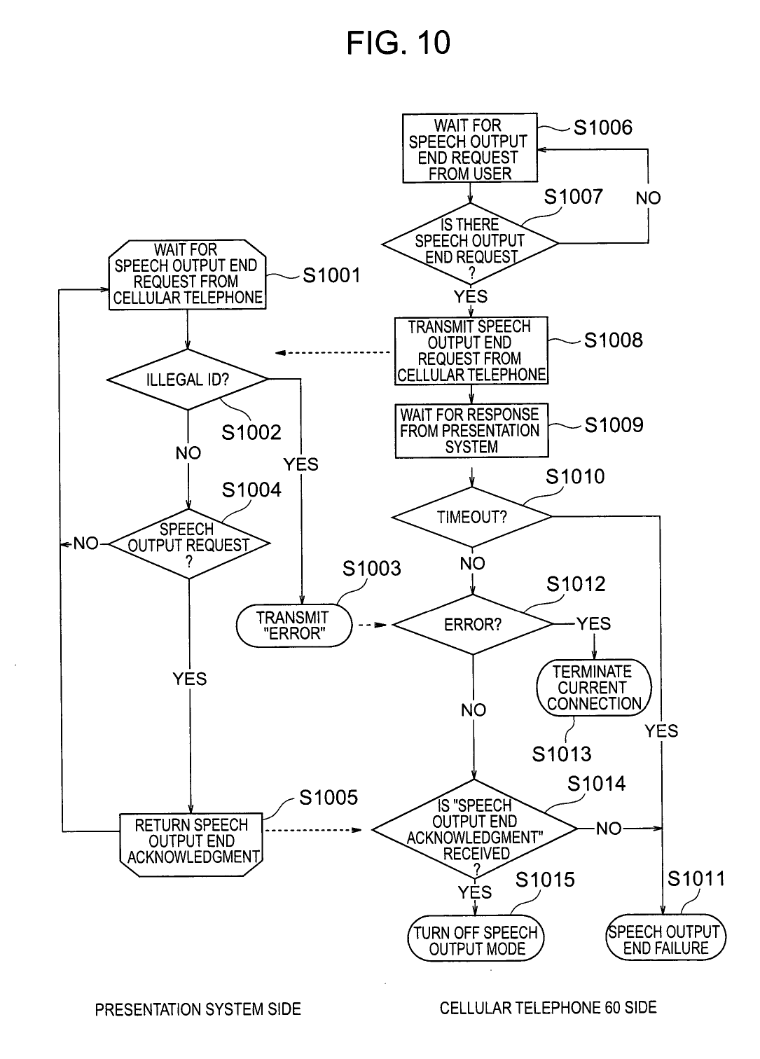

With reference to a flow chart shown in FIG. 10, operation of the presentation system shown in FIG. 3 at the time of speech output end request will now be described.

Presentation system side:

1) A speech output end request from the questioner cellular telephone 60 is waited for (S1001).

2)If something is transmitted from the questioner cellular telephone 60, then it is determined whether an ID transmitted simultaneously is an ID that is now in use. If the ID transmitted simultaneously is an ID that is not now in use, then an “error” message is returned to the questioner cellular telephone 60, and the processing is finished (S1002 and S1003).

3)If the ID transmitted simultaneously is the correct ID and the simultaneously transmitted input information of the questioner cellular telephone 60 indicates “speech output end,” then a “speech output end acknowledgment” message is returned and the processing for the speech output end request is completed (S1004 and S1005).

4)A subsequent speech output end request from a questioner cellular telephone is waited for (S1001).

The questioner cellular telephone 60 side:

1) The questioner cellular telephone 60 waits for the user to conduct operation for indicating “speech output end” by using the input unit thereon (S1006).

2)If “speech output start” is input, then the questioner cellular telephone 60 transmits an ID now held thereby and a message indicating “speech output end” to the presentation system, and waits for a response from the presentation system (S1007, S1008 and S1009).

3)If timeout occurs, then it turns out a “speech output end failure” and a message for informing the user to that effect is output on the screen (S1010 and S1011).

4)If an “error” message is received, then the questioner cellular telephone 60 regards the current connection as illegal, discards the ID held thereby, and deletes the cursor image on the screen as well (S1012 and S1013). If necessary, the processing is started from the “connection request” processing again (S501 in FIG. 5).

5)If the “speech output end acknowledgement” message is received, then the “speech output mode” in the questioner cellular telephone 60 is set to “OFF” and the speech output end request processing is completed. If necessary, for example, a display representing “speech is being output” on the screen of the questioner cellular telephone 60 is deleted (S1014 and S1015).

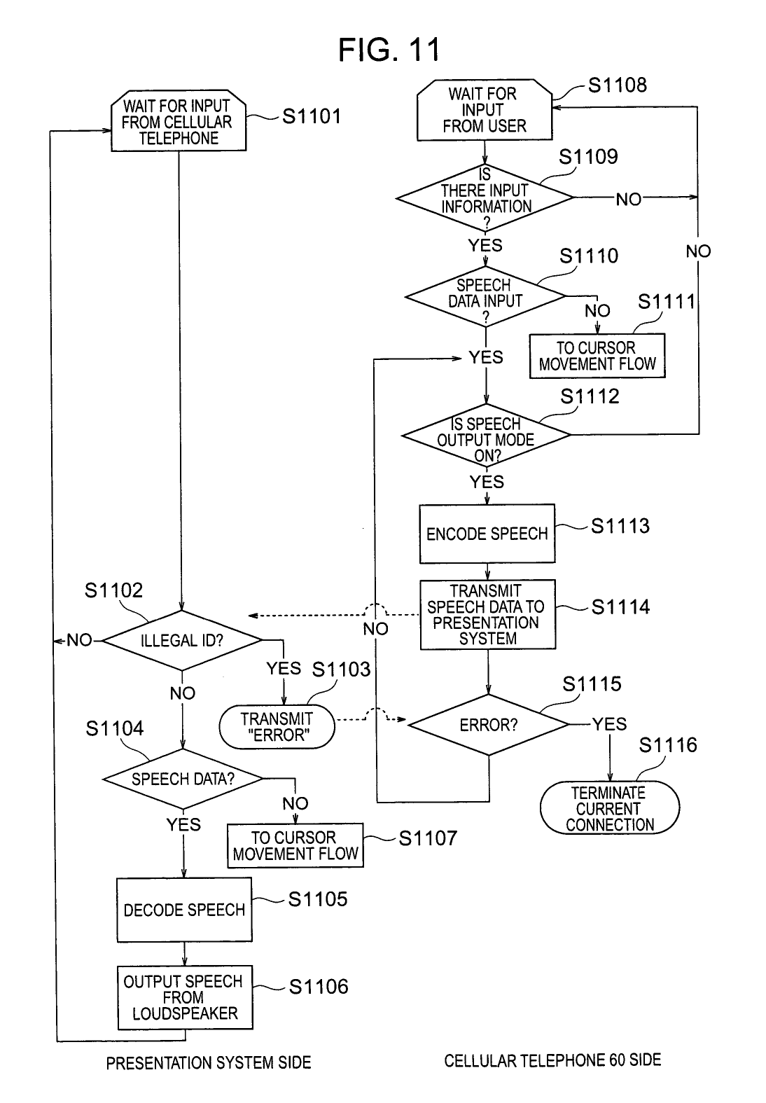

With reference to a flow chart shown in FIG. 11, operation of cursor movement and speech output in the presentation system shown in FIG. 3 will now be described.

Presentation system side:

1) Transmission of “speech data” from the questioner cellular telephone 60 is waited for (S1010).

2)If any information is transmitted from the questioner cellular telephone 60, then it is determined whether an ID transmitted simultaneously is an ID that is now in use. If the ID transmitted simultaneously is an ID that is not now in use, then an “error” message is returned to the questioner cellular telephone 60, and the processing is finished (S1102 and S1103).

3)If the ID transmitted simultaneously is the correct ID and input information of the questioner cellular telephone 60 transmitted simultaneously is “speech data,” then speech decoding is conducted and speech outputting is conducted by using the loudspeaker (S1102, S1104, S1105 and S1106).

4)If the input information is not “speech data,” then processing is conducted in the “cursor movement operation (FIG. 7)” (S1107).

5)Subsequent “speech data” from a questioner cellular telephone is waited for (S1101).

The questioner cellular telephone 60 side:

1) The questioner cellular telephone 60 waits for the user to input “speech data” or “cursor movement information” by using the microphone and the cursor input unit of the questioner cellular telephone 60 (S1108).

2)If the input information is not “speech data,” then processing is conducted in the “cursor movement operation (FIG. 7)” (S1109, S1110 and S1111).

3)If the input information is “speech data,” then it is determined whether the current “speech output mode” is “ON.” If the current “speech output mode” is “OFF,” then the input speech data is not transmitted to the presentation system (S1110 and S1112).

4)If the current “speech output mode” is “ON,” then the “speech data” is encoded and transmitted to the presentation system, and a response is waited for (S1112, S1113 and S1114).

5)If an “error” message is received, then the questioner cellular telephone 60 regards the current connection as illegal, discards the ID held thereby, and deletes the cursor image on the screen as well (S1115 and S1116). If necessary, the processing is started from the “connection request” processing again (S501 in FIG. 5).

6)If a “speech output completion” message is received, then it is determined whether the “speech output mode” of the questioner cellular telephone 60 is “ON.” If the “speech output mode” is “ON,” then the processing is repeated from the step S1112.

As heretofore described, the present invention provides a configuration in which information input by using an input unit included in a mobile terminal device is transmitted to a presentation computer and the presentation computer draws a cursor on a presentation screen. As a result, a lecturer and a questioner can easily specify a location on the presentation screen, and it is possible to bring about a better understanding between the lecturer and a questioner.

In addition, by adding a storage device and a file acquisition device to the configuration, the questioner can easily acquire information opened to the public concerning the presentation.

By adding a device for combining and separating speech and cursor position information to the presentation computer in the configuration, it becomes possible to implement outputting speech supplied from a mobile terminal, such as a cellular telephone, having a speech input unit like a microphone, from a speaker by using a loudspeaker device included in the presentation system. The labor and time required for a clerk in charge in the lecture meeting to move a microphone whenever a question is put can be reduced.

By adding an information form conversion device to the configuration, presentation information opened to the public can be acquired in an information form that can be handled by an individual mobile terminal device.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A presentation system for performing presentation by using a display device, comprising:
a computer unit connected to at least radio transmitter-receiver means and said display device;
a plurality of mobile terminal devices communicating with said computer unit via said radio transmitter-receiver means; and
control means incorporated in said computer unit to provide input information from said mobile terminal devices on said display device.

2. The presentation system according to claim 1, wherein said mobile terminal device includes a PDA (Personal Digital Assistant) having said radio transmitter-receiver means owned by at least a lecturer who performs presentation and persons taking the lecture.

3. The presentation system according to claim 1, wherein said control unit includes cursor control means together with a computer program for controlling cursor position information in order to indicate a display on a screen of said display device.

4. The presentation system according to claim 1, further comprising storage means connected to said computer unit to store data in relation with the presentation.

5. The presentation system according to claim 1, wherein said control unit includes a file acquisition unit together with a computer program for acquiring data stored in said storage means in accordance with an indication and selection by the mobile terminal devices.

6. The presentation system according to claim 1, wherein said control unit includes information format transforming means for transforming data stored in said storage means to an information format for the mobile terminal devices.

7. A presentation system for performing presentation by using a display device, comprising: a computer unit connected with at least radio transmitter-receiver means and said display device;
a plurality of mobile terminal devices communicating with said computer unit via said radio transmitter-receiver means; and
control means provided a loud speech amplified a speech transmitted from said mobile terminal devices via said radio transmitter-receiver means and incorporated in said computer unit to provide input information from said mobile terminal devices on said display device.

8. The presentation system according to claim 7, further comprising a loudspeaker unit including a speaker connected to said computer unit, said loudspeaker unit amplifying the speech from the mobile terminal devices.

9. The presentation system according to claim 8, wherein said control unit includes information synthesis and separation means for combining the input information and speech information supplied from the mobile terminal devices and separating the input information to be supplied to said display device and the speech information to be supplied to said loudspeaker unit.

10. The presentation system according to claim 7, wherein the mobile terminal device includes a cellular telephone.
